(19) United States
(12) Patent Application Publication
(10) Pub. No.: US 2023/0075411 A1
(43) Pub. Date: Mar. 9, 2023

(54) FINANCIAL PLANNING SYSTEM AND METHOD THEREOF

(71) Applicant: BRIGHT MONEY TECHNOLOGY PRIVATE LIMITED, Bangalore (IN)

(72) Inventors: Balkrishna JEPH, Bangalore (IN); Vivek SINGH, Asansol (IN); Saurav PATEL, Thane (IN); Varun Kumar MODI, Muzaffarpur (IN); Vishesh SHARMA, Gurgaon (IN); Amit Arun BENDALE, Ambalipura (IN); Alexander SEYFERT, San Francisco, CA (US); Avinash PATCHAVA, London (GB)

(73) Assignee: BRIGHT MONEY TECHNOLOGY PRIVATE LIMITED, Bangalore (IN)

(21) Appl. No.: 17/469,849

(22) Filed: Sep. 8, 2021

(51) Int. Cl. G06Q 40/06; G06Q 40/02

(52) U.S. Cl. CPC G06Q 40/06; G06Q 40/02

(57) ABSTRACT

A system and method for automated personalized financial planning is disclosed. The financial planning system includes a data receiving module for receiving a data input of at least one user account, a target information from the user. A manager module manages the data input. Further in, a machine-learning based prediction module derive learning from the data input for predicting a cashflow information. The financial planning system includes a planning module generating a financial plan based on the data input comprising of recommendation for achieving the target information.

### FIELD OF THE INVENTION

The present disclosure relates to a consumer financial technology tool and more particularly provides a system and method for recommending, projecting, customizing, and executing a personalized financial plan.

### BACKGROUND

Financial planning is a process of developing steps and strategies to guide people to attain their desired financial life goals in the short and long term by managing their financial affairs.

Financial planning allows people to better plan their current and future finances consisting of income, expenses, debts, savings, and investments so that they can achieve their financial goals and that too in the desired time-period. Conventionally these financial goals consist of reducing debts such as credit card, education loans, automobile loans, and debt equities alike, building savings, amassing wealth, tax planning, investment planning, owning a home, saving for retirement, attaining peace of mind etc.

Each person has a unique financial profile and aspirations from life, thus making financial planning a highly personalized and intricate process. Traditionally users have been seeking financial planning advice and consultations from two main sources—Professional consultants/Financial Advisors and/or use financial tools.

Professional consultants often investigate people's entire financial transactions including their income, expenses and suggest savings, investment, and expenditure plans. The professional consultants may perform a comprehensive evaluation of people's finances and design a plan to achieve future targeted financial goals using current known variables of cash flow and assets and liabilities. Professional consultants have been delivering financial planning consultations for a considerable period but are subjected to certain limitations.

Some notable limitations may include:
Financial consultants are expensive, ranging from $2,000 to $7,500 annually, restricting them to a limited number of people who can afford them
Financial consultants on average have a low touch point with their clients typically, once in 4 to 6 months. This low touch point prevents them from readjusting or recalibrating their plan to the constantly changing financial patterns and habits of people
With the constant advancements in technology, advanced algorithms and A.I have the ability to analyze people's transactional data in much more depth and thus being able to deliver more comprehensive and intelligent financial planning advice
Financial consultants come with human foibles and not just human strengths. The consultants are subject to their own emotional swings and always carry human fallibility risk.

Alternatively, there are a myriad of financial tools people use to obtain financial planning advice. These tools may require a person to manually enter their financial data/transactions or may have the option to read a person's historic financial transactions automatically post user consent to receive financial planning advice. However, these financial tools too fail to provide robust, intelligent, and complete financial planning to people.

Some notable limitations of the existing financial tools may include:
The existing financial tools lack support for linking and reading financial transactions for user's accounts across multiple banks
The existing financial tools do not provide all ambits of financial needs such as investment, loans, credit card, savings, tax planning, retirement planning within one tool
The existing financial tools predominantly use generic static algorithms for every user and fail to provide a personalized financial plan based on the user specific goals
The existing financial tools fail to provide a step-by-step prioritized set of intelligent recommendations using advanced algorithms and A.I
The existing financial tools are limited to provide only the financial recommendations but lack the ability to execute the recommendations on the user's behalf
The existing financial tools fail to provide active progress management against the financial goals set by the user
The existing financial tools lack course correction abilities and thus fail to adjust and adapt to the constantly changing financial habits and patterns of the users
The existing financial tools lack execution steps to process auto transactions for the users to assist the user remain compliant with may be payment due dates.

In an example to exemplify the limitation of the existing financial tools, consider when the user has multiple expenditure entities such as a credit card or a savings scheme, etc. and would like to ensure timely transactions towards such expenditure entities. The existing financial tools may not be able to provide the user with mechanisms to ensure automated deductions towards these expenditure entities.

In another example, to exemplify limitations of the existing financial tools, the user may not experience customized financial planning advice based on the user's past transactions, current balance. The existing financial tools may not be capable of deriving learning from the user's transactions and propose a customized financial plan. The user's requirement, to receive a guided, comprehensive approach for performing timely payments and achieving financial objectives alongside duly considering the user's past transactions, current balance is lacking from the already existing solutions in the fintech industry. In the case, if during execution of the financial planning, the user desires to edit goals or encounter transactions then it is desired that the financial planner must be robust to consider such edits and tuned accordingly.

Also, the existing financial tools may not be Artificial Intelligence (AI) driven methods. Thus, fail to bring insights into the financial planning otherwise concealed from generic algorithms or humans

Therefore, there is a need for a novel solution that overcomes the above deficiencies and provides users with a step-by-step, customized financial plan aiming to cater to the user's financial goals. The proposed solution with AI capacity may be able to consider multiple accounts of the user, assess transactions, display short-term and long-term projections, course correct and have the capability to self-execute the recommended steps of the customized financial planning.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment of the present invention, a system for financial planning is disclosed. The system includes a data receiving module configured to receive a data input of at least one user account, wherein the data input is indicative of the account information relating to a transaction ledger, balance, credit reports, transaction report, and loans information. The system includes receiving target information from the user, the target information being indicative of the user defined financial objective. The system includes a manager module in communication with the data receiving module and configured to manage the transaction ledger, wherein the transaction ledger being indicative of an expenditure entity and a transaction data of at least one user account. The system further includes a machine-learning based prediction module in communication with the data receiving module and the manager module and configured to derive learning from the data input and the transaction ledger for predicting a cash flow information, wherein the cash flow inflow comprising an income, an expense, and a balance for the at least one account associated with the user. The system includes a planning module in communication with the data receiving module, the manager module, and the prediction module, and configured to generate a financial plan based on the data input, the target information, the transaction ledger, and the cashflow information, wherein the financial plan comprising of recommendation for achieving the target information.

In another embodiment of the present invention, a method for financial planning is disclosed. The method includes, receiving a data input of at least one user account, wherein the data input is indicative of the account information relating to a transaction ledger, balance, credit reports, transaction report, and loans information. The method includes, receiving target information from the user, the target information being indicative of the user defined financial objective. The method includes, managing the transaction ledger, wherein the transaction ledger being indicative of an expenditure entity and transaction data of at least one user account. The method further includes, deriving learning from the data input and the transaction ledger for predicting a cash flow information, wherein the cash flow information comprising an income, an expense, and a balance for the at least one account associated with the user. The method includes, generating a financial plan based on the data input, the target information, the transaction ledger, and the cashflow information, wherein the financial plan comprising of recommendation for achieving the target information.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram depicting an environment of implementation of a financial planning system, according to an embodiment of the present disclosure;

FIG. 2 illustrates a block diagram of the financial planning system, according to an embodiment of the present disclosure;

FIG. 3 illustrates a flowchart depicting a method for financial planning, according to an embodiment of the present disclosure;

FIG. 4 illustrates a flowchart depicting a method for the data input 108 in the data receiving module of the system, according to an embodiment of the present disclosure;

FIG. 5 illustrates a flowchart depicting a method for managing the transaction ledger, according to an embodiment of the present disclosure;

FIG. 6 illustrates a flowchart depicting a method for the cashflow prediction based on the transaction ledger, according to an embodiment of the present disclosure;

FIG. 7 illustrates a flowchart depicting a method for generating the financial plan, according to an embodiment of the present disclosure;

FIG. 8 illustrates a flowchart depicting a method for executing recommendations of the financial plan, according to an embodiment of the present disclosure;

FIG. 9 illustrates a flowchart depicting a method for determining the timeline of expenditure entity, according to an embodiment of the present disclosure;

FIG. 10 illustrates a flowchart depicting a method for intercommunication of the execution module, according to an embodiment of the present disclosure; and

FIG. 11 illustrates a flowchart depicting a method 1000 for determining execution of the financial plan is in conformity with the projection displayed to the user 104, according to embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of the ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more element is required.”

Unless otherwise defined, all terms and especially any technical and/or scientific terms, used herein may be taken to have the same meaning as commonly understood by a person ordinarily skilled in the art. Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure. Embodiments of the present invention will be described below in detail with reference to the accompanying drawings.

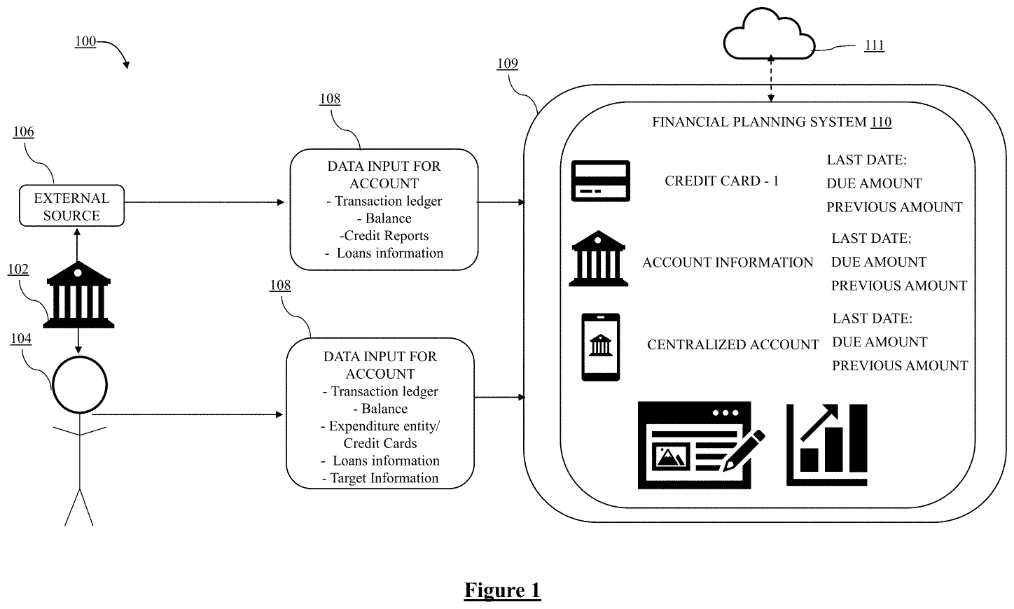

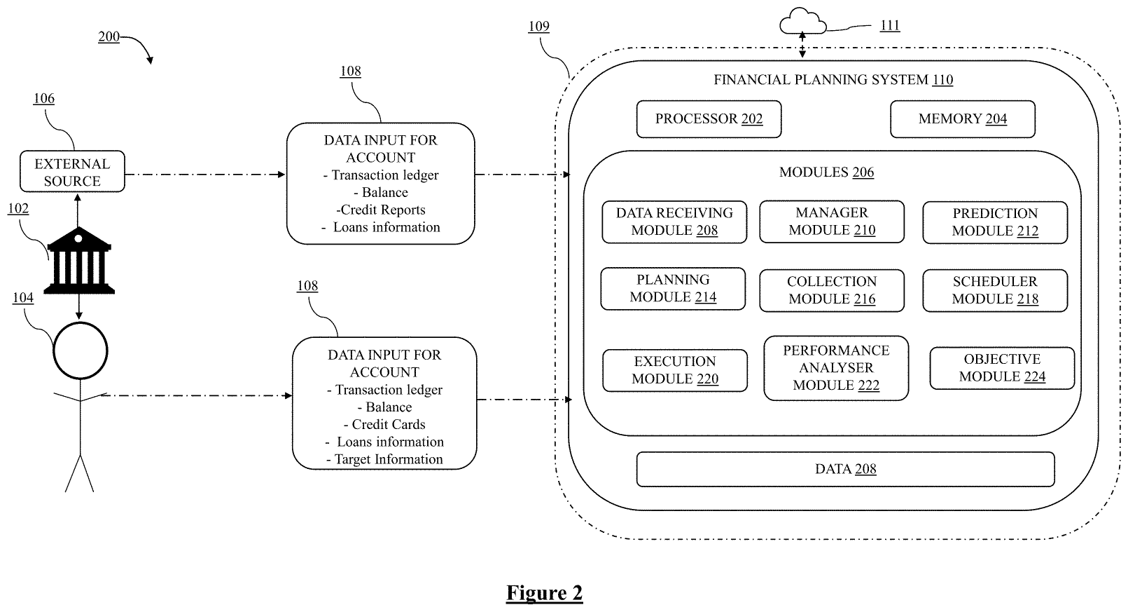

FIG. 1 illustrates a block diagram 100 depicting an environment 100 of implementation of a financial planning system, according to an embodiment of the present disclosure. FIG. 2 illustrates a block diagram 200 of the financial planning system 110, according to an embodiment of the present disclosure. For the sake of brevity, the financial planning system 110 is hereinafter interchangeably referred to as the system 110.

The system 110 may be implemented in a user device 109 to be accessed by a user 104.

The system 110 may be residing in the user device as an application installed in the user device 109 and/or as a Software as a service (SaaS) application. The system 110 is adapted to receive a data input 108 from the user 104 and an external source 106. The system 110 upon receiving the data input 108, processes the data input 108 for generating a financial plan.

In an embodiment, the user 104 is the true owner of an account 102. In an example embodiment, the account 102 is understood as a financial account but not limited to be held by banks or another financial institutions. The financial account maintained by bank or other financial institution for the user may be considered as the financial account. It represents the funds entrusted by the user to the financial institution and the user may make withdrawals from it. In an example the account may be a checking account, a savings account, a mutual fund account, an annuity account, a credit account, a debit account, or any kind of investment account thereof. In the example, the account 102 is associated with the user 104 and is generally related or governed by the financial institutions. In an example the account 102 may be a centralized account related to the system 110 and the centralized account being associated with the user 104. The centralized account being governed by the system 110. In an embodiment, the user 104 may have more than one account 102 associated. In an example, the user 104 may be associated with the account including, the checking account, the savings account, the loan account, the credit account, the centralized account, and other accounts alike.

In an embodiment, the user 104 interacts with the system 110 through the user device 109. The system 110 is implemented as an application or/and as SaaS on the user device 109 and provides a user interface to the user 104 for communication with the system 110. In an example, the system 110 is in communication to a cloud 111. The system 110 may communicate the user 104 interaction to the cloud 111. The user 104 may communicate with the system 110 may be by creating a user profile and providing user credentials. The user 104 may perform a subscription with the system 110 by arranging to exchange data through the user interface of the application. The subscription may include registering with the system 110, exchanging data, and exploring results of the system 110. The user 104 with the subscription may control the system 110 interaction with the user 104 or data associated with the user 104. In the example, the user 104 may be able to edit the subscription. The user 104 may terminate the subscription thus either deleting the user profile or by means of putting an end to data exchange with the system 110. Alternatively, the user 104 may choose to temporarily pause the subscription, thus allowing the system 110 to still exchange data with the user 104 but the system 110 may not execute processing of the data for generating any associated results. Subsequently, the user 104 may not be able to view any results or financial plan processed by the system 110.

Upon successful subscription of the system 110, in an embodiment, the user 104 provides the data input 108 to the system 110. In an example embodiment, the data input 108 from the user 104 being provided to the system 110 may include: a transaction ledger, a present balance information, an expenditure entity, a credit card(s), a loan information or input alike which relates to the financial transactions/activities of the user 104 from the account 102. In the example, the expenditure entity may include at least one of a credit card, a saving scheme, an investment scheme or other arrangements which may require the user 104 to perform a transaction from the account 102 and fulfill the requirement of the expenditure entity. In the example, the transaction may be the financial proceedings related to transferring funds in or out from the account 102. In the example, the expenditure entity may relate to payment of the credit card, payment of monthly installment, purchasing mutual fund, buying stocks, and other transacting entities alike. In the embodiment, the user 104 provides a target information to the system 110. In an example, the target information may include the user 104 defined financial objectives/goals that the user 104 aspires to achieve.

The user 102 provides the data input 108 to the system 110 for generating the financial plan.

In an embodiment, the external source 106 provides the data input 108 to the system 110. In an example, the data input 108 from the external source 106 provided to the system 110 may include: the transaction ledger, the account information for credit, the account information for loans, the transaction ledger, present balance. In the example, the external source 106 may include a unified aggregator. The unified aggregator for example, is an external agency competent to connect with the financial institutions governing the account 102 associated with the user 104. The unified aggregator may derive the account 102 information to be provided as the data input 108 to the system 110. In another example, the external source 106 may include a credit bureau. The credit bureau for example, is an external agency competent to provide credit reports by connecting with the financial institutions governing the account 102 associated with the user 104. The credit bureau may derive the account 102 information to be provided as the data input 108 to the system 110.

In an embodiment of the invention, the system 110 receives the data input 108 from the user 104 or the external source 106 and is indicative of the account 102 information. The system 110 processes the data input 108 for generating the financial plan.

In an embodiment of the invention, the system 110 in the user device is in communication using a router. The router may provide a network for communicating any data over the network to the system 110. Further, the data may be transmitted or received over the network via the router. The network may include wired networks, wireless networks, Ethernet AVB networks, or combinations thereof. The wireless network may be a cellular telephone network, an 802.11, 802.16, 802.20, 802.1Q, or WiMax network. Further, the network may be a public network, such as the Internet, a private network, such as an intranet, or combinations thereof, and may utilize a variety of networking protocols now available or later developed including, but not limited to TCP/IP based networking protocols.

In an embodiment, the system 110 is installed in the user device and receives the data input 108 with the user interface from the user 104 through the application. The system 110 may include the application adapted to be installed in the user device of the user 104. The system 110 may include the application operating as the SaaS on the user device. The user device may include, but is not limited to, a tablet PC, a Personal Digital Assistant (PDA), a mobile-device, a palmtop computer, a laptop computer, a desktop computer, a server, a cloud server, a remote server, a communications device, a wireless-telephone, or any other machine controllable through the wireless-network and capable of executing a set of instructions (sequential or otherwise) that specify actions to be taken by that machine. The application may be adapted to share notifications relating to financial planning and to receive data input 108 from the user 104 or the external source 106.

FIG. 2 illustrates a block diagram 200 of the system 110, according to an embodiment of the present disclosure. The financial planning system 110 may include, but is not limited to, a processor 202, memory 204, modules 206, and data 208. The modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulate signals based on operational instructions.

Further, the modules 206 can be implemented in hardware, instructions executed by a processing unit, or by a combination thereof. The processing unit can comprise a computer, a processor, such as the processor 202, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

In an embodiment, the modules 206 may include a data receiving module 208, a manager module 210, a prediction module 212, a planning module 214, a collection module 216, a scheduler module 218, an execution module 220, a performance analyzer module 222, and an objective module 224 may be in communication with each other. The data 208 serves, amongst other things, as a repository for storing data processed, received, and generated by one or more of the modules 206.

Referring to FIG. 1 and FIG. 2, the data receiving module 210 may be adapted to receive the data input 108 of the account 102 associated with the user 104. In an example embodiment, the data receiving module 208 is configured to receive the data input 108 from the user 104 or the external source 106 wherein the data input 108 includes the account 102 information relating to the transaction ledger, balance, credit reports, transaction report, loans information. In the example, the data input 108 includes the target information provided by the user 104. The data receiving module 208, intelligently sorts the account 102 information to identify the type of account 102 information. In the example, the data receiving module 208 receives the transaction ledger from the user 104 or the external source 106 for the account 102 associated with the user 104. The transaction ledger may include but not limited to, summary of all funds entered in supporting journals which list individual transactions by date and further includes accounts for assets, liabilities, users' equity, revenues, and expenses. The transaction ledger may include but not limited to every activity on the account 102 associated with the user 104.

In the example, the data receiving module 208 receives the credit card(s) related to the account 102 associated with the user 104. The data receiving module 208 further receives information from the transaction ledger corresponding to the credit card(s) for example, due date for payment, minimum amount to be paid, last transaction with the credit card(s). Similarly, in another example but not limiting to the data receiving module 208 is configured to receive the savings scheme related to the account 102 associated with the user 104. The data receiving module 208 further receives information from the transaction ledger corresponding to the savings scheme for example, amount due to be paid in the savings scheme, last date of payment, current balance in savings.

In an embodiment, the data receiving module 208 receives the target information from the user 104. In an example, the target information may include the user 104 defined financial objective(s)/goal(s) that the user 104 aspire to achieve.

In an embodiment, the data receiving module 208 may not receive any data input 108 from the user 104 or the external source 106 for the account 102 associated with the user 104. In the example, the user 104 provides the account 102 associated with the user 104 but the data input 108 related to the account 102 information is not provided either by the user 104 or the external source 106. The data receiving module 208 may be implement, a machine learning approach with deep neural network to derive learnings from the data input 108 provided in the past. The deep learning model is trained with the past data input 108 to predict the data input 108 in absence of receiving the data input 108 from the user 104 or the external source 106. In an example, the deep learning model is trained with the past data input 108 received from the external source 106 to train and predict the data input 108 when the user 104 does not provide any data input 108. In the example, the user 104 provides the data input 108 for the credit card and fails to provide the due date or minimum payment due for the credit card. The deep learning technique of data receiving module 208 will predict the due date or minimum payment due for the credit card based on the data input 108 collected from the external sources 106 in the past.

The manager module 210 is in communication with the data receiving module 208. The manager module 210 is configured to manage the transaction ledger. The transaction ledger may include but not limited to, a transaction data including summary of all funds entered in supporting journals which list individual transactions by date and further includes accounts for the expenditure entity.

In an embodiment, the manager module 210 may have sub-modules for managing the expenditure entity. In an example, the expenditure entity being credit card may have a credit sub-module for managing the credit card. In the example, the credit sub-module may have the transaction data for said credit card. The transaction data may include, payment due date, minimum amount to be paid, balance to be paid and data alike.

In the embodiment, the manager module 210 may have sub-modules for managing the expenditure entity. In an example, the expenditure entity being the checking account. In an example, the expenditure entity being the checking account may have a depository sub-module for managing the transaction data for said checking account. The transaction data may include, the amount credited, the amount debited from the account 102 associated with the user 104.

In the embodiment, the manager module 210 may have sub-modules for managing the expenditure entity based on type of the expenditure entity.

A prediction module 212 is in communication with the data receiving module 208 and the manager module 210. The prediction module 212 is configured to derive learning from the data input 108 and the transaction ledger for predicting a cashflow information. In an example the cashflow information may be including, an income, an expense, a balance for the at least one account 102 associated with the user 104. In the example embodiment, the prediction module 212 applies machine learning for predicting the income of the user 104. The prediction module 212 is trained with the historical data representing the income i.e., the amount credited in the user's 104 account 102. In the example embodiment, the prediction module 212 applies machine learning for predicting the expenditure of the user 104. The prediction module 212 is trained with the historical data representing the expenditure i.e., the amount debited in discretionary and non-discretionary form from the user's 104 account 102. In the example embodiment, the prediction module 212 applies machine learning for predicting a balance of the user 104. The prediction module 212 is trained with the historical data representing the balance i.e., the amount remaining the user's 104 account 102. In an example, the prediction module 212 derive learning from the data input 108 received from the external source 106. The data input 108 received from the external source 106 provides training set to the prediction module 212 for predicting the cashflow information. In the embodiment, the cashflow information is representation of the user's 104 present funds/amount statistics along with income and expenditure. The cashflow information may become basis for generating the financial plan.

A planning module 214 is in communication with the data receiving module 208, the manager module 210 and the prediction module 212. In an embodiment, the planning module 214 is configured to generate the financial plan based on, the data input 108, the target information, the transactional ledger and the cashflow information.

In the embodiment, the planning module 214 generates the financial plan including recommendations using machine learning models taking into account the users data and optimizing it to his target goals in the shortest path and time possible. In the example, the recommendations may be but not limited to, executable set of instructions. The planning module 214 considering the transactional ledger and the cashflow information may be provide the set of instructions which are when executed results in the transactions from the user's 104 account 102. The recommendations generated by the planning module 214 are aligned with the target information provided by the user 104, such that generated financial plan aims to achieve the target information when the recommendations are executed.

In an example, the planning module 214 in communication with the manager module receives the expenditure entity being the credit card. The planning module 214 further receives the transaction data for the credit card. The transaction data may be including, payment due date, minimum amount to be paid, balance to be paid and data alike. The planning module 214 in communication with the prediction module 212 receives the cashflow information for determining the current statistics of the user's 104 account 102. The planning module in communication with the data receiving module 208 receives the target information of the user 104. In the example, the planning module 214 is configured to generate the financial planning by outlining the due date for the credit card payment and further recommendations which when allowed by the user 104 to be executed may perform transactions for achieving the target information. In the example, the planning module 214 prioritizes the recommendations in accordance with achieving the target information. In the example, the planning module 214 is configured to determine the timelines for performing transactions or payment by the due dates for the expenditure entity being the credit card.

In another example, the planning module 214 in communication with the manager module receives the expenditure entity being the savings scheme. The planning module 214 further receives the transaction data for the savings scheme. The transaction data may be including, payment due date, minimum amount to be paid, balance to be paid and data alike. The planning module 214 in communication with the prediction module 212 receives the cashflow information for determining the current statistics of the user's 104 account 102. The planning module in communication with the data receiving module 208 receives the target information of the user 104. In the example, the planning module 214 is configured to generate the financial planning by outlining the due date for the savings scheme payment and further recommendations which when allowed by the user 104 to be executed may perform transactions for achieving the target information. In the example, the planning module 214 prioritizes the recommendations in accordance with achieving the target information. In the example, the planning module 214 is configured to determine the timelines for performing transactions or payment by the due dates for the expenditure entity being the savings scheme.

In an embodiment, the planning module 214 provides a graphical display of the generated financial plan. In an example, the financial plan is displayed to the user 104, wherein the user 104 may view recommendations of the financial plan in a graphical projection. The graphical projection displays the financial plan from visual perspective of the user 104 detailing step-by-step projections of recommendation to be executed by the system 110.

Furthermore, the graphical projection provides ease to the user 104 for determining the transactions in form of recommendations provided by the planning module 214. The user 104 may be able to decipher from the graphical projection a step-by-step transaction events planned to achieve the target information.

In an example embodiment, the planning module 214 is configured to receive an input from the user 104 for editing the financial plan. The user 104 post viewing the recommendations of the financial plan desire to edit the recommendations. The planning module 214 is configured to receive the input as instructions for editing the recommendations of the generated financial plan from the user 104. In the example, the financial plan generated includes recommendation to deduct $X from the account 102 on a certain date and perform transaction to deposit $X towards the expenditure entity such as the savings scheme considering the target information provided by the user 104 includes achieving X-amount in the savings scheme. Now, in the example, the user 104 may be able to provide the input for editing the amount to be deducted and the date for the transaction. Also, in another example, the user 104 may be able to provide the input for editing the sequence of transaction. The planning module 214 is configured to receive the input from user 104 for editing the sequence of recommendations of the financial plan. The planning module 214 shall accept the input from the user 104 and proceed accordingly. In the example, the planning module 214 based on the input from the user 104 edits the generated financial plan.

In an embodiment, the planning module 214 is configured to track an active state of the expenditure entity. In an example, the active state of the expenditure entity may include but not limited to, tracking the transaction executed for the expenditure entity. In an example, the expenditure entity being the credit card. The planning module 214 tracks the transaction made for the credit card payment. In another example, the planning module 214 tracks whether the account 102 associated with the user 104 is in active state and other expenditure entity are in active state for executing transactions. The planning module 214 is configured to track completion of the transaction towards the expenditure entity.

In another example embodiment, the plan module 214 in communication with the data receiving module 208, the manager module 210 and prediction module 212 suggest a service to the user 104. The service may be indicative of an additional feature of the system 110 not mentioned by the user 104 in the target information. In the example, the user 104 may be having surplus balance in the account 102. The user in the target information does not provide any savings scheme for saving or investing the surplus balance in the account 102. The planning module 214 displays the suggestive service, suggesting the user 104 to invest the surplus amount in the suggestive service such as the savings scheme or stock market or any other suggestive service of the system 110 alike.

The collection module 216 is in communication with the data receiving module 208, the manager module 210, and the planning module 114. The collection module 216 is configured to execute the recommendation. In an example, execution of the recommendation may include but not limited to, the transaction performed from the account 102 associated with the user 104. The transaction is performed towards the expenditure entity. In the example, the expenditure entity being the credit card, and the generated financial plan provides recommendation to perform the transaction for payment of amount towards the credit card by the due date. The collection module 216 upon receiving the instructions from the planning module 214 performs transaction by debiting the amount from the user's 104 account 102 and deposit the amount towards the expenditure entity being the credit card.

In an embodiment of the invention, the collection module 216 is configured to execute recommendation of the financial plan. In the embodiment the execution may be based but not limited to, on learning from the transaction ledger for determining a frequency and a limitation of transactions.

In the example embodiment, the collection module 216 while executing recommendation, in form of the transaction from the account 103 associated with the user 104 to the expenditure entity, the execution step is based on a pre-defined constraints. The pre-defined constraints are representation of rules being defined by the user 104 or the financial institutions, or the government policies or any other regulation providing a check on the transactions of funds from the user's 104 account 102.

In the embodiment the execution may be but not limited to, based on the pre-defined constraints defined by the user 104. The user 104 may be for example, create a rule for establishing a threshold value for the transaction amount being debited from the account 102.

In the embodiment the execution may be but not limited to, based on a bank or financial institutions applied guidelines as the pre-defined constraints for performing transaction and determining frequency and limits of transactions. The bank or financial institutions may be for example, create the rule for establishing the threshold value for the transaction amount being debited from the account 102 associate with the user 104.

In the embodiment the execution may be but not limited to, a user-defined criteria for executing transaction. In an example, the user-defined criteria may be for example, monthly goal limit, maximum collection in certain time interval.

In an embodiment of the invention, the collection module 216 collects the amounts from the account 102 associated with the user 104 towards the centralized account. In an example, the centralized account is associated with the user 104. In the example, the centralized account is managed and governed by the system 110. The centralized account may act as a dummy virtual account 102 for the user 104 wherein the system 110 manages the centralized account for transactions and the centralized account may still be governed by the financial institution. In an example, the user 104 may be associated with multiple accounts 102. The multiple accounts 102 may have different transaction ledger and hence the balance amount in multiple account 102 may vary. Now, as each account may have multiple expenditure entity associated and the user 104 may desire to execute transaction towards expenditure entity. The collection module 216 executes the transaction from the multiple account 102 and collects the amount in the centralized account with the system 110. Now, the transaction towards multiple expenditure entity is executed from the collected amount in the centralized account instead of each of the multiple account 102. In an embodiment, the collection module 216 is configured with means for approval, fraud, and validation checks. The collection module 216 may implement machine learning algorithms for approval, fraud, and validation checks and determines a probability factor using the machine learning models to control and decide which collections to pass and which to stop.

The scheduler module 218 is in communication with the manager module 210, the planning module 214 and the collection module 216. In an embodiment, is configured to receive instructions from the collection module 216 for determining a timeline of the transaction for the expenditure entity. In an example embodiment, the scheduler module 218 determines the timeline based on the user input. In the example, the user 104 may be scheduling the transaction i.e., at a certain time interval or at a certain event the transaction may be executed for transfer of fund/amount from the account 102 towards the expenditure entity.

In an example, the scheduler module 218 determines the timeline of transaction of the expenditure entity, based on recommendation of the financial plan. In the example, the scheduler module 218 is configured to execute transaction as per the recommendations of the financial plan. The recommendations of the financial plan provide the time interval or the event triggering execution of the transaction for transfer of fund/amount from the account 102 towards the expenditure entity. In the example, the generated financial plan provide recommendation for payment of funds to the expenditure entity being the credit card by the due date. The scheduler module 218 in communication with the planning module 214 is configured to determine the timeline i.e., for example the due date for payment of the credit card due amount.

In an embodiment, the scheduler module 218 is in communication with the collection module 216. The scheduler module 218 provides the scheduling timeline to the collection module 216 for executing the transaction from the account 102 associated with the user 104.

In an embodiment, the scheduler module 218 upon failure to schedule the execution of the transaction from the account 102 associated with the user 104 transmit a message to the user 104. In an example, the message to the user 104 includes notifying the user regarding failure to schedule the payment. In the example, the user 104 provided the user input for executing the transaction for the payment of credit card dues on certain date. Now, if the account does not have sufficient balance to execute transaction for payment of credit card due then the scheduler module 218 transmits the message to the user 104 regarding shortage of amount in the account 102 and inability to execute the transaction.

The execution module 220 is in with the data receiving module 208, the prediction module 212, the planning module 214 and the collection module 216. In an embodiment, the execution module 220 is configured to enable intercommunication between the data receiving module 208, the prediction module 212, the planning module 214 and the collection module 216 upon receiving the user input. In an example embodiment, the execution module 220 calibrates the system 110 and modules 206 upon receiving the user input deviating from the recommendations of the financial plan.

The performance analyzer module 222 is in communication with the planning module 214 and the execution module 220. In an embodiment, the performance analyzer module 222 is configured to determine on a real-time basis using machine learning models that the execution of the financial plan is performed in conformity with the projections displayed to the user 104. Furthermore, the machine learning models help determine that the recommendations of the financial plan are performed in conformity with the projections, and if not, then the performance analyzer module 222 is configured to communicate feedback to the execution module 220. The execution module 220 thereafter establishes the intercommunication of the modules 206 and calibrate the system to align execution of recommendations of the financial plan in conformity with the projections displayed to the user 104.

The objective module 224 is in communication with the manager module 210, the planning module 214. In an embodiment the objective module 224 is configured to provide suggestions to customize the financial plan based on the transaction data of the account 102 associated with the user 104. In an example, the objective module 224 in communication with the manager module 210 determines the transaction ledger for determining user's 104 recent spends, current financial status, deletion, or addition of new expenditure entity. The objective module 224 in communication with the planning module 214 determines the recommendations for the transactions provided in the generated financial plan. In the example, the objective module 224 then compares data from the manager module 210 and planning module 214 and provide suggestions to the user 104 for editing the recommendations for the transactions in the generated financial plan. In an example, the objective module 224 in communication with the manager module 210 determines a new credit of funds in the account 102 of the user 104. In the example, the objective module 224 in communication with the manager module 210 determines that the generated financial plan has not recommended to utilize the new credit of funds then the objective module 224 may be providing suggestions to the user 104 for editing the financial plan and utilize the new credit of funds.

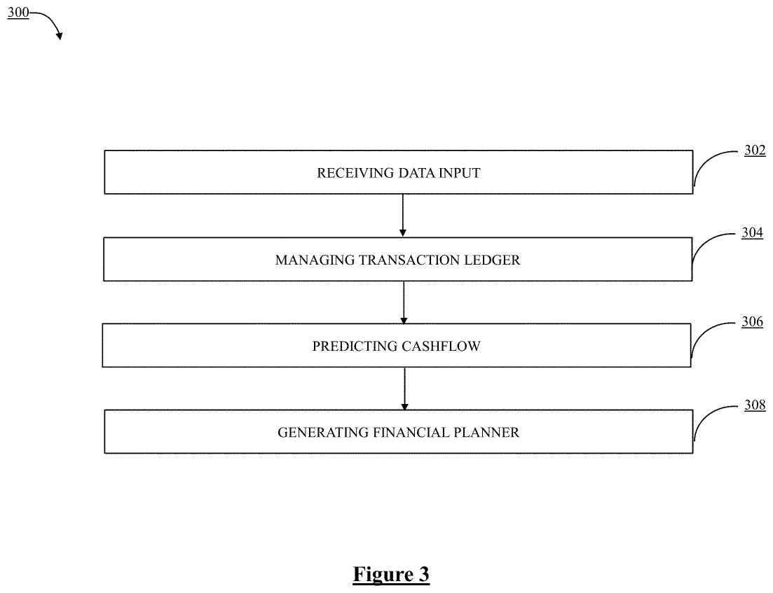

FIG. 3 illustrates a flow chart depicting a method 300 for financial planning, according to an embodiment of the present disclosure. The method 300 may be a computer-implemented method executed, for example, by the system 110. For the sake of brevity, constructional and operational features of the system 110 that are already explained in the description of FIG. 1 and FIG. 2, are not explained in detail in the description of FIG. 3.

At step 302, the method includes receiving a data input of the one user account. The data input is indicative of the account information relating to a transaction ledger, balance, credit reports, transaction report, and loans information. The data input is received from the user or from the external source.

The data input may include a target information received from the user. The target information is being indicative of the user defined financial objective.

The method further includes deriving learning through deep neural network for predicting the data input. The data input is predicted in absence of receiving the data input from the user or the external source.

At step 304, the method includes managing the transaction ledger. The transaction ledger being indicative of the expenditure entity and the transaction data of the user account. The managing of the transaction ledger may be includes determining the expenditure entity associated with the user and the transaction data.

At step 306, the method includes deriving learning from the data input and the transaction ledger for predicting a cashflow information. The cashflow information comprising an income, an expense, and a balance for the at least one account associated with the user.

At step 308, the method includes generating a financial plan based on the data input, the target information, the transaction ledger, and the cashflow information. The financial plan includes recommendation for achieving the target information.

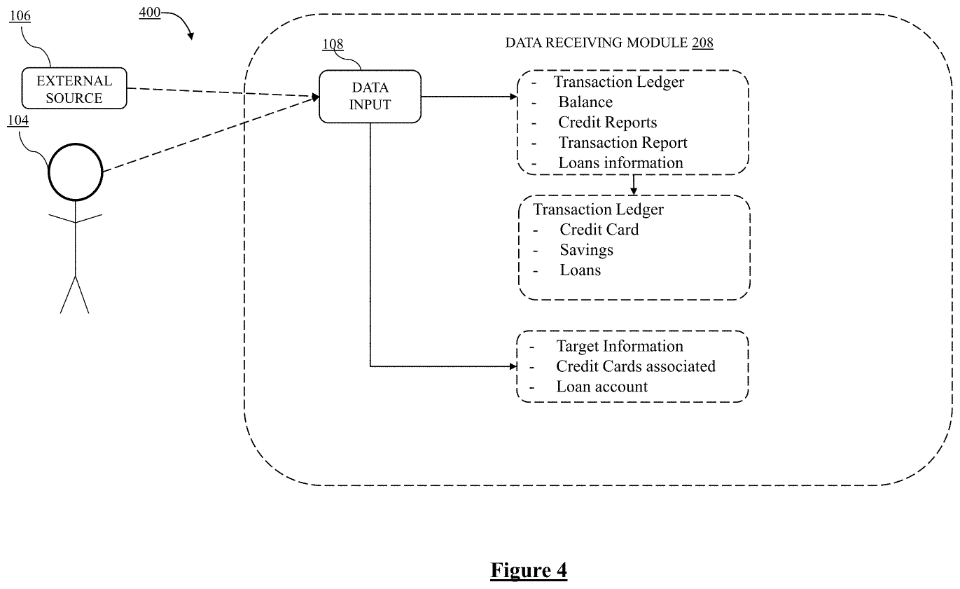

FIG. 4 illustrates a flowchart depicting a method 400 for the data input 108 in the data receiving module 208 of the system 110, according to an embodiment of the present disclosure. The method 400 may be a computer-implemented method executed, for example, by the data receiving module 208. For the sake of brevity, constructional and operational features of the system 110 that are already explained in the description of FIG. 1 and FIG. 2, are not explained in detail in the description of FIG. 4.

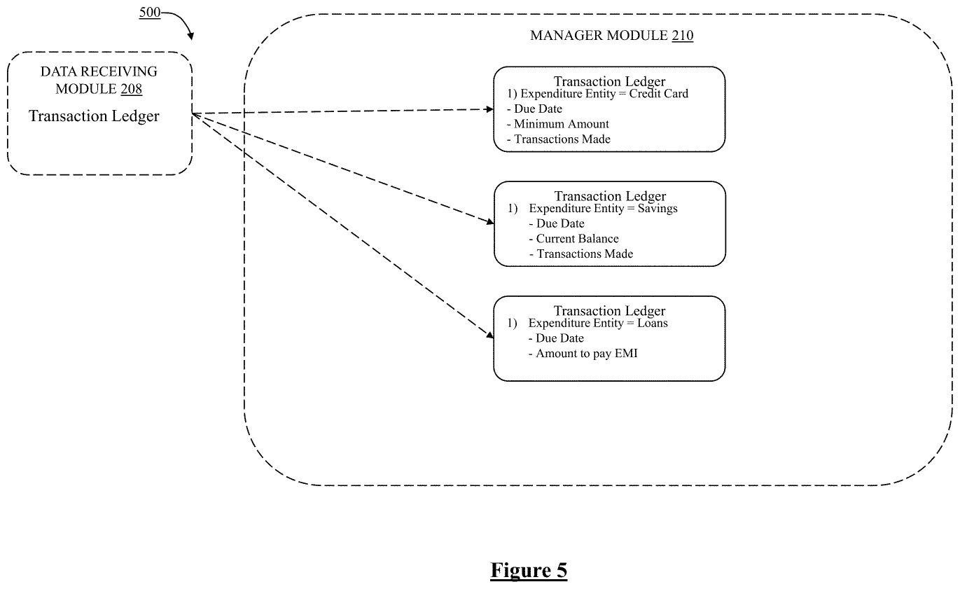

FIG. 5 illustrates a flowchart depicting a method 500 for managing the transaction ledger, according to an embodiment of the present disclosure. The method 500 may be a computer-implemented method executed, for example, by the manager module 210 of the system 110. For the sake of brevity, constructional and operational features of the system 110 that are already explained in the description of FIG. 1 and FIG. 2, are not explained in detail in the description of FIG. 5.

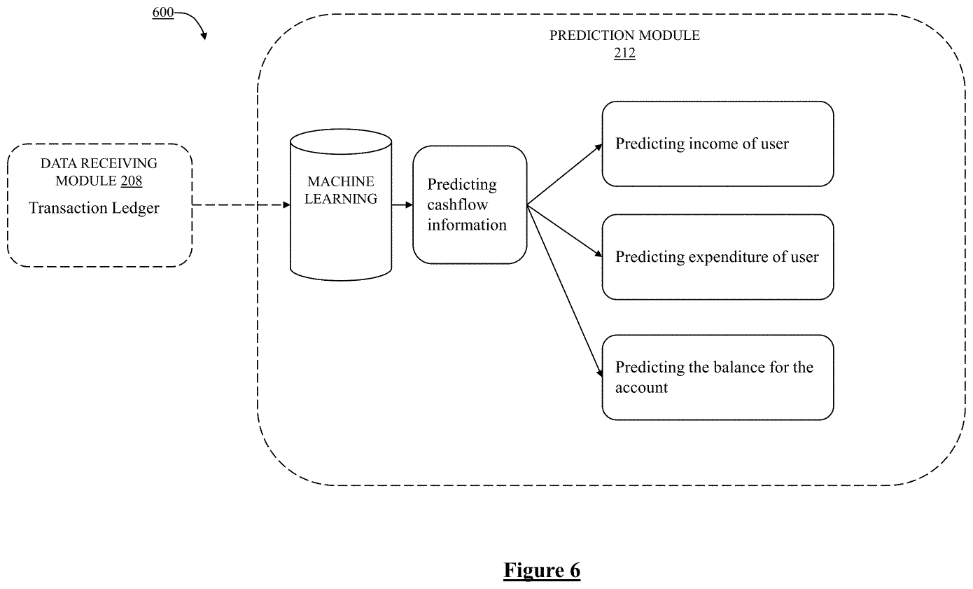

FIG. 6 illustrates a flowchart depicting a method 600 for the cashflow prediction based on the transaction ledger received from the data receiving module 208, according to an embodiment of the present disclosure. The method 600 may be a computer-implemented method executed, for example, by the prediction module 212 of the system 110. For the sake of brevity, constructional and operational features of the system 110 that are already explained in the description of FIG. 1 and FIG. 2, are not explained in detail in the description of FIG. 6.

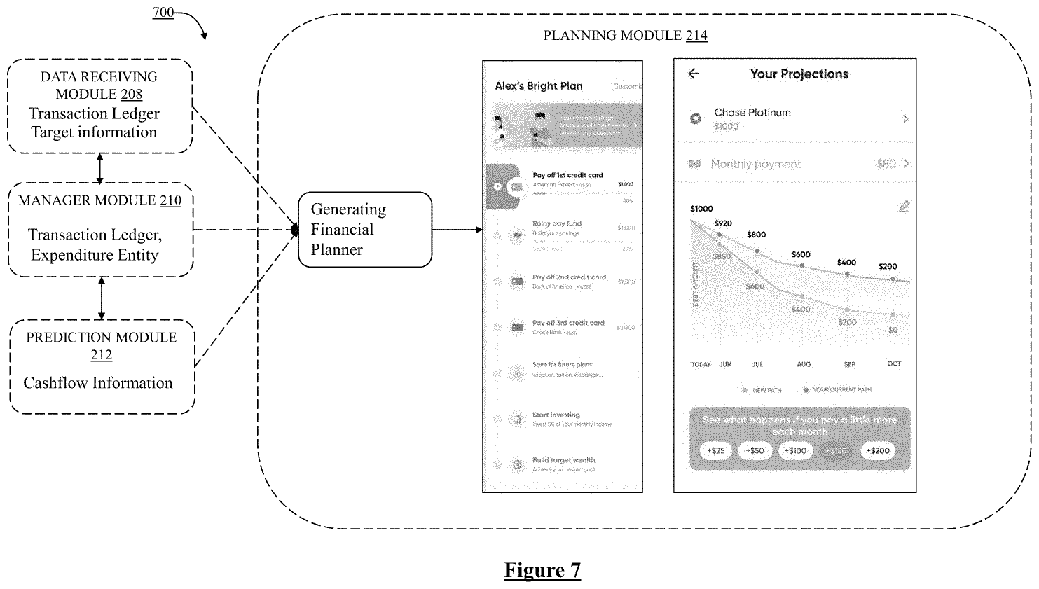

FIG. 7 illustrates a flowchart depicting a method 700 for generating the financial plan, according to an embodiment of the present disclosure. The method 700 may be a computer-implemented method executed, for example, by the plan module 214 of the system 110. For the sake of brevity, constructional and operational features of the system 110 that are already explained in the description of FIG. 1 and FIG. 2, are not explained in detail in the description of FIG. 7.

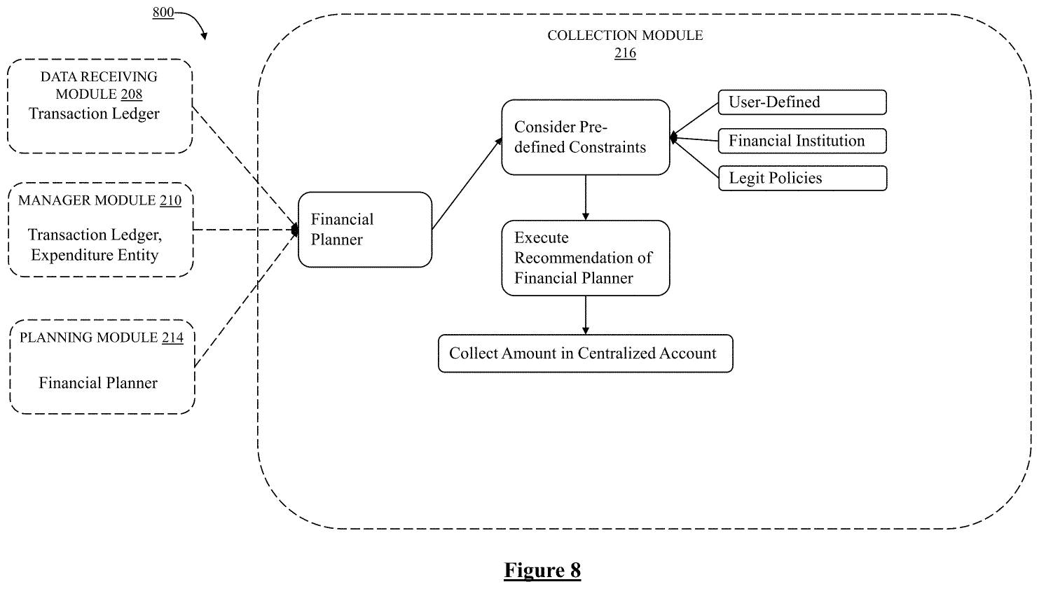

FIG. 8 illustrates a flowchart depicting a method 800 for executing recommendations of the financial plan, according to an embodiment of the present disclosure. The method 800 may be a computer-implemented method executed, for example, by the collection module 216 of the system 110. For the sake of brevity, constructional and operational features of the system 110 that are already explained in the description of FIG. 1 and FIG. 2, are not explained in detail in the description of FIG. 8.

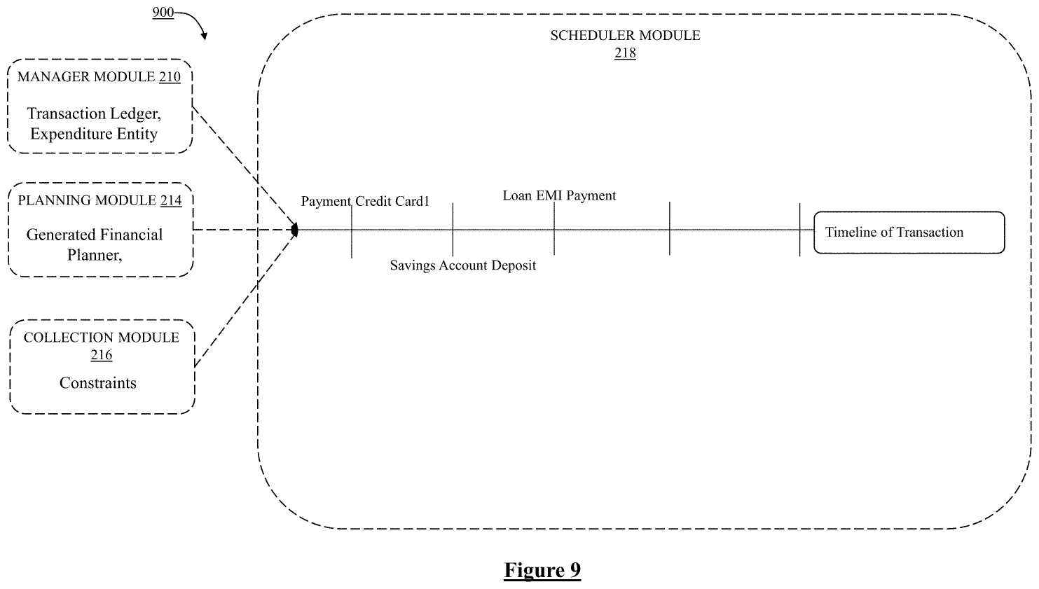

FIG. 9 illustrates a flowchart depicting a method 900 for determining the timeline of expenditure entity, according to an embodiment of the present disclosure. The method 900 may be a computer-implemented method executed, for example, by the scheduler module 218 of the system 110. For the sake of brevity, constructional and operational features of the system 110 that are already explained in the description of FIG. 1 and FIG. 2, are not explained in detail in the description of FIG. 9.

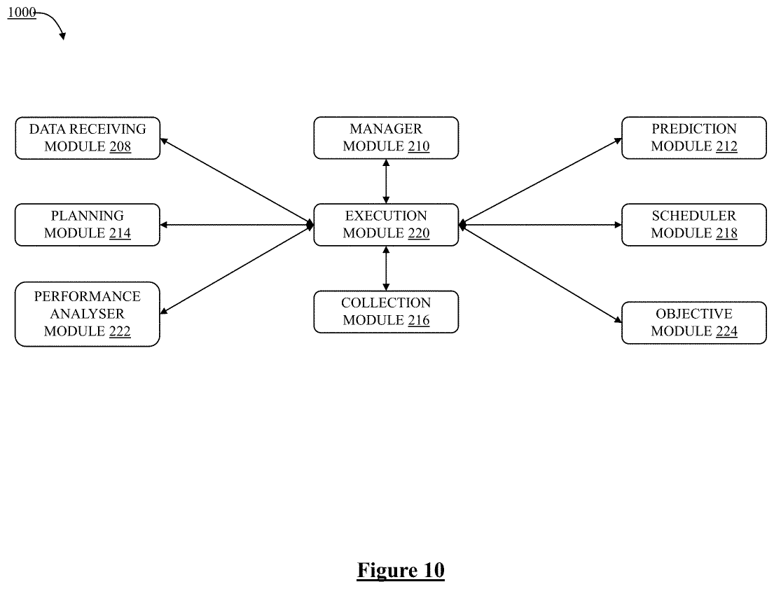

FIG. 10 illustrates a flowchart depicting a method 1000 for intercommunication of the execution module 220, according to an embodiment of the present disclosure. The method 900 may be a computer-implemented method executed, for example, by the execution module 220 of the system 110. For the sake of brevity, constructional and operational features of the system 110 that are already explained in the description of FIG. 1 and FIG. 2, are not explained in detail in the description of FIG. 10.

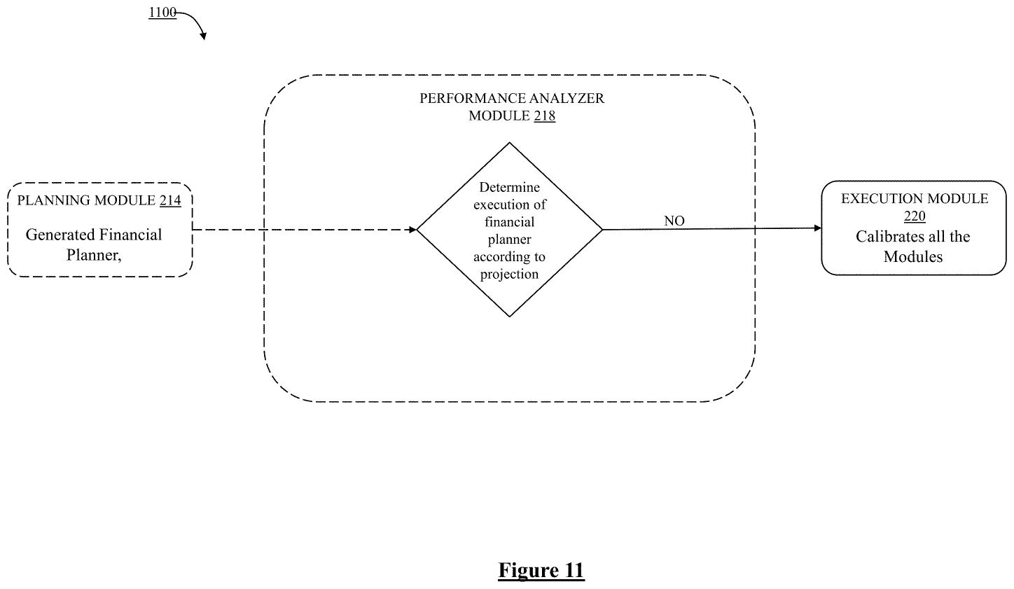

FIG. 11 illustrates a flowchart depicting a method 1100 for determining execution of the financial plan is in conformity with the projection displayed to the user 104, according to embodiments of the present disclosure. The method 1000 may be a computer-implemented method executed, for example, by the performance analyzer module 218 of the system 110. For the sake of brevity, constructional and operational features of the system 110 that are already explained in the description of FIG. 1 and FIG. 2, are not explained in detail in the description of FIG. 11.

The present invention provides following technical advantages:
1. The present invention provides a personalized financial plan generated in short span time for any user based on income and expenses, spending patterns, cashflows, and future aspirations.
2. The present invention provides user-friendly graphic simulation detailing each milestone in the financial plan step by step to ensure clear actions rather than unordered and randomly distributed steps to achieve financial freedom.
3. The present invention provides the ability to see impact projections in the short term and long term of following the financial plan as well as seeing the effects of editing the various inputs to the financial plan.
4. The present invention provides the ability to automatically execute transactions in the financial plan. The financial plan works with machine learning techniques.
5. The present invention provides the financial plan which continuously adapts and adjusts to keep user on track through reordering steps and execution details like allocation of frequency and amount of the funds towards the steps in the plan basis your changing finances compared to other solutions that are not self-adjusting or take a long time to adjust.
6. The present invention provides real time progress management for the user to always be on top of his finances and see daily progress compared to having very little visibility on impact of the plan.
7. The present invention provides automatic course correction in execution tactics if the progress gets delayed or astray to get back on track for results compared to not knowing or taking large amounts of time to identify that the user is off track and then suggest course correction mechanisms.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

I/WE CLAIM:

1. A system for financial planning comprising:
a data receiving module configured to:
receive a data input of at least one user account, wherein the data input is indicative of the account information relating to a transaction ledger, balance, credit reports, transaction report, and loans information;
receive a target information from the user, the target information being indicative of the user defined financial objective;
a manager module in communication with the data receiving module and configured to manage the transaction ledger, wherein the transaction ledger being indicative of an expenditure entity and a transaction data of the at least one user account;
a machine-learning based prediction module in communication with the data receiving module and the manager module and configured to derive learning from the data input and the transaction ledger for predicting a cashflow information, wherein the cashflow inflow comprising an income, an expense, and a balance for the at least one account associated with the user; and
a planning module in communication with the data receiving module, the manager module, and the prediction module, and configured to generate a financial plan based on the data input, the target information, the transaction ledger, and the cashflow information, wherein the financial plan comprising of recommendation for achieving the target information.

2. The system according to claim 1, wherein the receiving module is configured to derive learning from the received data input and predict the data input, in absence of receiving the data input from the user or an external source.

3. The system according to claim 1, wherein the planning module is configured to:
receive an input from the user for editing the financial plan; and
display a graphical simulation of the financial plan comprising at least of timeline and milestone for executing the target information.

4. The system according to claim 1, wherein the planning module is configured to:
track an active state of the expenditure entity;
track completion of at least one transaction to the expenditure entity;
display a suggestive service.

5. The system according to claim 1, comprising a collection module in communication with the data receiving module, the manager module, and the planning module, and configured to execute recommendation in form of at least one transaction from the at least one user account towards the expenditure entity.

6. The system according to claim 5, wherein the collection module is configured to:
perform the at least one transaction from the at least one user account into a centralized account; and
execute the at least one transaction from the centralized account.

7. The system according to claim 5, wherein the collection module is configured to execute recommendation of the financial plan, wherein the execution is based on learning from the transaction ledger for determining a frequency and a limitation of transactions, a pre-defined constraint by the user or a bank for performing transaction and determining frequency and limits of transactions, and a user-defined criteria for executing transaction.

8. The system according to claim 5, comprising a scheduler module in communication with the manager module, the planning module, and the collection module, and is configured to:
receive instructions from the collection module to determine a timeline of transaction for the expenditure entity, wherein the expenditure entity being indicative at least one of a credit card, a saving scheme, and an investment scheme, based on the transaction ledger;
determine the timeline of transaction of the expenditure entity, based on the user input and recommendation of the financial plan; and
schedule the at least one transaction based on the timeline.

9. The system according to claim 8, wherein the scheduler module is configured to transmit a message to the user upon failure to schedule the at least one transaction.

10. The system according to claim 1, comprising:
an execution module in communication with the data receiving module, the prediction module, the planning module, and the collection module, and configured to intercommunicate the data receiving module, the prediction module, the planning module, and the collection module upon receiving the user input.

11. The system according to claim 1, comprising:
a performance analyzer module in communication with the data receiving module, the prediction module, the planning module, and the collection module, and configured to:
determine whether recommendation of the financial plan is performed; and
provide a feedback upon determining that the recommendation of the financial plan is not performed.

12. The system according to claim 11, comprising:
the execution module in communication with the performance analyzer module and configured to receive the feedback and calibrate intercommunication between the data receiving module, the prediction module, the planning module, and the collection module for executing recommendation of the financial plan.

13. The system according to claim 1, comprising:
an objective module in communication with the data receiving module, the manager module, the prediction module, and the planning module, and configured to provide suggestions to customize the financial plan based on the transaction data of the at least one account associated with the user.

14. A method for financial planning comprising:
receiving a data input of at least one user account, wherein the data input is indicative of the account information relating to a transaction ledger, balance, credit reports, transaction report, and loans information;
receiving a target information from the user, the target information being indicative of the user defined financial objective;
managing the transaction ledger, wherein the transaction ledger being indicative of an expenditure entity and a transaction data of the at least one user account;
deriving learning from the data input and the transaction ledger for predicting a cashflow information, wherein the cashflow information comprising an income, an expense, and a balance for the at least one account associated with the user; and
generating a financial plan based on the data input, the target information, the transaction ledger, and the cashflow information, wherein the financial plan comprising of recommendation for achieving the target information.

15. The method according to claim 14, comprising deriving learning from the received data input and predicting the data input, in absence of receiving the data input from the user or the external source.

16. The method according to claim 14, comprising:
receiving an input from the user for editing the financial plan; and
displaying a graphical simulation of the financial plan comprising at least of timeline and milestone for executing the target information.

17. The method according to claim 14, comprising:
tracking an active state of the expenditure entity;
tracking completion of at least one transaction to the expenditure entity;
displaying a suggestive service.

18. The method according to claim 14, comprising executing recommendation in form of at least one transaction from the at least one user account towards the expenditure entity.

19. The method according to claim 18, comprising:
performing the at least one transaction from the at least one user account into a centralized account; and
executing the at least one transaction from the centralized account.

20. The method according to claim 18, wherein executing recommendation of the financial plan is based on learning from the transaction ledger for determining a frequency and a limitation of transactions, a pre-defined constraint by the user or a bank for performing transaction and determining frequency and limits of transactions, and a user-defined criteria for executing transaction.

21. The method according to claim 18, comprising:
receiving instructions to determine a timeline of transaction for the expenditure entity, wherein the expenditure entity being indicative at least one of a credit card, a saving scheme, and an investment scheme, based on the transaction ledger;
determining the timeline of transaction of the expenditure entity, based on the user input and recommendation of the financial plan; and
scheduling the at least one transaction based on the timeline.

22. The method according to claim 21, comprising transmitting a message to the user upon failure to schedule the at least one transaction.

23. The method according to claim 14, comprising:
determining whether recommendation of the financial plan is performed; and
providing a feedback upon determining that the recommendation of the financial plan is not performed.

24. The method according to claim 14, comprising:
receiving the feedback; and
calibrating intercommunication for executing recommendation of the financial plan.

25. The method according to claim 14, comprising providing suggestions to customize the financial plan based on the transaction data of the at least one user account.
